(19) United States
(12) Patent Application Publication
(10) Pub. No.: US 2015/0134169 A1
(43) Pub. Date: May 14, 2015

(54) APPARATUS FOR CONTROLLING DRIVING OF A MOTOR

(71) Applicant: SAMSUNG SDI CO., LTD., Yongin-si (KR)

(72) Inventors: Jae-Woo KAM, Yongin-si (KR); Hiroaki TAKECHI, Yongin-si (KR); Won-Chull HAN, Yongin-si (KR)

(21) Appl. No.: 14/508,040

(22) Filed: Oct. 7, 2014

(30) Foreign Application Priority Data
Nov. 11, 2013 (KR) 10-2013-0136511

(51) Int. Cl. B60L 11/18; B60L 15/20; B60L 3/12

(52) U.S. Cl. CPC B60L 11/1861; B60L 11/1809; B60L 3/12; B60L 15/20
USPC 701/22

(57) ABSTRACT

An apparatus includes a controller to output a signal through an interface. The signal may control at least one parameter of a motor based on a state of capacity degradation of a battery for driving the motor. The at least one parameter may be motor torque. Also, the signal may include a value indicative of a capacity degradation of a battery for driving a motor. The capacity degradation of the battery may be determined based on a number of charging and/or discharging operations performed for the battery.

### CROSS-REFERENCE TO RELATED APPLICATION

Korean Patent Application No. 10-2013-0136511, filed on Nov. 11, 2013, and entitled, “Apparatus For Controlling Driving Of Electric Bike,” is incorporated by reference herein in its entirety.

### BACKGROUND

1. Field

One or more embodiments herein relate to a controller for an electronic or electromechanical device or system.

2. Description of the Related Art

Unlike a primary battery, a rechargeable battery can be repeatedly charged and discharged. A rechargeable battery is usually included in a battery pack with a battery management system (BMS). The battery pack is used for powering mobile phones, camcorders, power drills, and other small electronic devices. Battery packs have also been used to power hybrid and electric cars.

Now, there is a growing interest in the development of electric bikes for use as commuting vehicles as well as for pleasure. Like electric cars, electric bikes are expected to operate based on battery power.

### SUMMARY

In accordance with one embodiment, an apparatus for controlling driving of an electric bike includes a motor to rotate a wheel of an electric bike; a battery to provide power to the motor; a battery manager to calculate a capacity degradation value of the battery; and a motor driver to control torque of the motor according to the capacity degradation value of the battery. The motor driver may reduce the torque and/or another parameter of the motor depending on the capacity degradation value of the battery.

The battery manager may transmit the capacity degradation value of the battery to the motor driver. The battery manager may calculate the capacity degradation value according to a number of charging and/or discharging operations performed for the battery. The battery manager may calculate the capacity degradation value according to a difference between a charging capacity of the battery at a fully discharged state and an initial charging capacity of the battery.

In accordance with another embodiment, an apparatus includes an interface; and a controller to output a signal through the interface, where the signal is to control at least one parameter of a motor based on a state of capacity degradation of a battery for driving the motor. The at least one parameter may be torque and/or another parameter of the motor.

The controller may include a driver coupled to the motor and a battery manager to determine a value indicative of the capacity degradation of the battery. The battery manager may output the value to the driver for generating the signal to control the at least one parameter. The battery manager may determine the value indicative of the capacity degradation of the battery based on a number of operations performed for the battery. The number of operations performed for the battery may include at least one of a number of battery charging operations or a number of battery discharging operations.

The apparatus may further include a storage device to store a look-up table, wherein the look-up table includes a plurality of capacity degradation values corresponding to a respective plurality of numbers of operations performed for the battery, and wherein the battery manager is to determine the value indicative of the capacity degradation of the battery with reference to the look-up table.

The battery manager may determine the capacity degradation of the battery based on information indicative of a capacity of the battery in a fully discharged state, an initial capacity of the battery, and a capacity of the battery determined based on the number of operations performed for the battery. The interface may include a signal line located between the controller and battery.

In accordance with another embodiment, an apparatus includes an interface and a controller to output a signal through the interface, wherein the signal includes a value indicative of a capacity degradation of a battery for driving a motor. The controller may determine the value indicative of the capacity degradation of the battery based on a number of operations performed for the battery. The number of operations performed for the battery may include at least one of number of battery charging operations or a number of a battery discharging operations.

The apparatus may include a driver to drive the motor, wherein the driver generates a signal to control at least one parameter of the motor based on the signal indicative of the capacity degradation of the battery. The at least one parameter may include torque of the motor. The interface may be a signal in line located between the controller and motor.

The controller may determine the value indicative of the capacity degradation of the battery based on a search of a look-up table of capacity degradation values stored in association with corresponding values indicative of a number of charging and/or discharging operations performed for the battery.

### BRIEF DESCRIPTION OF THE DRAWINGS

Features will become apparent to those of skill in the art by describing in detail exemplary embodiments with reference to the attached drawings in which:

FIG. 1 illustrates an embodiment of a controller for a motor;

FIG. 2 illustrates an electric bike controlled by the controller; and

FIG. 3 illustrates an embodiment of a method for driving a motor of a device.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

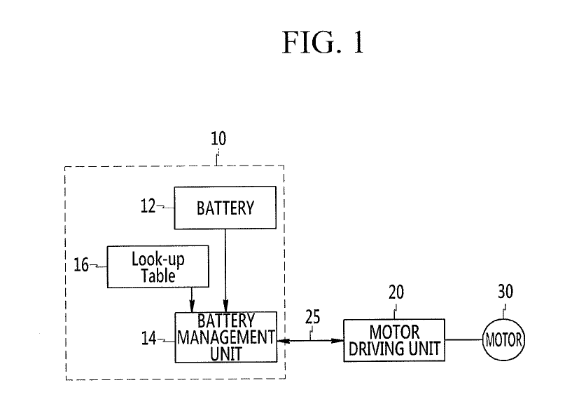

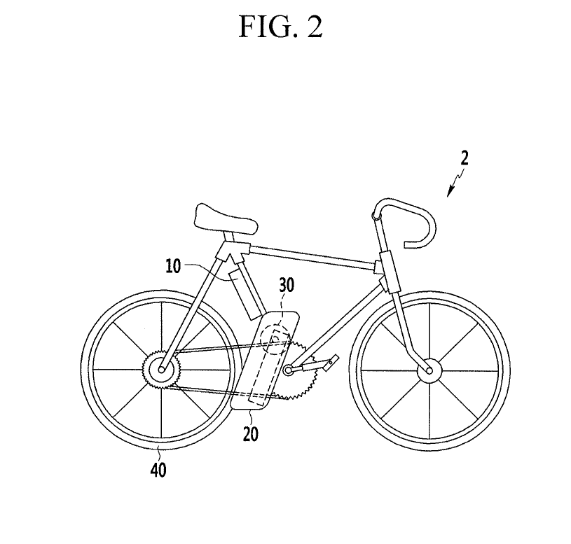

FIG. 1 illustrates an embodiment of an apparatus for controlling a motor. FIG. 2 illustrates an electric bike which may be one of many types of electric or hybrid vehicles that may be controlled by the apparatus in FIG. 1.

Referring to FIG. 1, the apparatus includes a battery pack 10, a motor driving unit 20, and a motor 30. The battery pack 10 provides a predetermined level or range of driving power for the motor 30. In one embodiment, battery pack 10 includes a battery 12 and a battery management unit 14. The battery 12 includes at least one battery cell, and may be repeatedly charged and discharged. The battery 12 may be a lithium ion battery cell or another type of cell.

The battery management unit 14 determines a capacity degradation value by determining a state of degradation of battery 12. The degradation state may be determined based on the number of charging and/or discharging operations performed for battery 12. As the number of charging and/or discharging operations increase, the operational capabilities of battery 12 are expected to degrade. For example, the full charging capacity of battery 12 may gradually decrease as the number of charging and/or discharging operations increase.

To determine the capacity degradation value, the battery management unit 14 may measure, or count, the number of charging and/or discharging operations of the battery 12. The battery management unit 14 may determine the capacity degradation value according to the number of charging and/or discharging operations. In this regard, the battery management unit 14, taken alone or in combination with motor driving unit 20, may be considered to be a controller or battery manager.

In one embodiment, the capacity degradation value may be determined based on a look-up table 16 to be accessed by battery management unit 14. For example, a look-up table may be stored in advance in the battery management unit 14, or in a memory coupled to this unit. The look-up table may store a plurality of capacity degradation values for a corresponding plurality of numbers of charging and/or discharging operations. The correspondence between these numbers and the capacity degradation values may be experimentally determined or determined, for example, based on a predetermined percentage which changes either linearly or non-linearly as the number of charging and/or discharging operations increase.

In other embodiments, the battery management unit 14 may calculate the capacity degradation value, for example, based on a predetermined equation, e.g., without the use of a look-up table. The predetermined equation may be based on the aforementioned changing percentage, and/or may take one or more parameters into consideration such as, but not limited to, the type of battery cell in battery 12, the level of charging current applied during a charging operation, the age of the battery 12, the temperature of the battery 12, and/or other external or internal influences or parameters.

Additionally, or alternatively, the battery management unit 14 may calculate the capacity degradation value based on a comparison of the charging capacity of battery 12 in a fully discharged state with an initial charging capacity. Over time, the battery 12 may store less charge in the fully charged state due to capacity degradation. At any given time, the amount of charge stored in the battery 12 after a full charging operation may be compared to initial charging capacity and the capacity degradation value may be determined based on this comparison.

For example, the capacity degradation value (CDV) may be calculated as:

CDV=(C−B)/(A−B)

Where A is the initial charging capacity of battery 12, B is a value corresponding to battery 12 in a fully discharged state, and C is the measured charge in battery 12 after a full charge operation after one or more battery charging and/or discharging operations have been performed for battery 12.

The battery management unit 14 sends the capacity degradation value to the motor driving unit 20. The battery management unit 14 sends this value through an interface. In one embodiment, the interface may be a signal line between battery management unit 14 and motor 30, e.g., signal line 25 between battery management unit 14 and motor driving unit 20. In another embodiment, the interface may be a conductive line inside of the battery management unit 14. If battery management unit 14 and motor driving unit 20 are combined to form a controller, the interface may be an internal conductive line of the battery management unit 14.

The motor driving unit (or motor driver) 20 receives the capacity degradation value of battery 12, and controls driving of motor 30 according to the degradation capacity of the battery 12.

In one embodiment, motor driving unit 20 may reduce a maximum torque of motor 30 by a predetermined ratio as the capacity degradation value of the battery increases or exceeds a reference value. The motor 30 is driven by being controlled by the motor driving unit 20. The motor 30 may be used as an auxiliary power source, as shown in FIG. 2, for a wheel 40 of the electric bike 2. The motor 30 controls the electric bike 2 to be driven by rotating the wheel 40 of the electric bike 2.

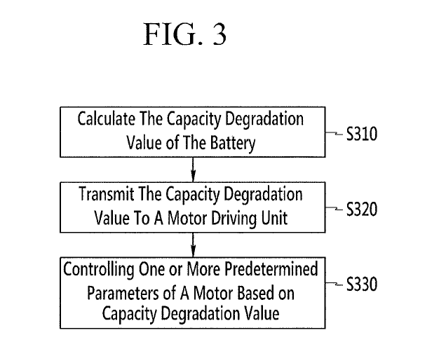

FIG. 3 illustrates operations included in one embodiment of a method for driving the motor of an electric or hybrid vehicle, such as the electric bike in FIG. 2. Initially, in operation 310, the battery management unit 14 calculates the capacity degradation value of the battery 12. In operation S320, the battery management unit 14 transmits the capacity degradation value of the battery 12 to the motor driving unit 20 over a signal line or other type of communication link.

In operation 5330, the motor driving unit 20 controls one or more predetermined parameters of the motor 30 based on the capacity degradation value of battery 12. In one embodiment, the motor driving unit may adjust (e.g., reduce) the maximum torque of the motor 30 based on the capacity degradation value of the battery 12. For example, when the maximum torque of the motor 30 is 100 N and the capacity degradation value of the battery 12 is 10 percent of the initial full charging capacity, the motor driving unit 20 may reduce the maximum torque to 90 N.

Accordingly, rotating force of the wheel 40 of the electric bike 2 by a user is increased by a value corresponding to the decreased amount of torque of the motor 30 (i.e., 10 N). That is, a driving distance of electric bike 2 may be constantly maintained by decreasing the driving force of the motor 30 according to the degradation state of the battery 12 under the same driving conditions.

Accordingly, even if the remaining capacity of the battery is decreased, a driving time of the motor 30 may be constantly maintained. This may prevent electric bike 2 from being halted by the sudden operational stopping of the motor 30.

In other embodiments, the motor driving unit may adjust torque and/or one or more other parameters including but not limited to motor speed, a motor constant, operating current or voltage, frequency, or phase control.

Some of the aforementioned embodiments have described controlling an electric bike 2. In other embodiments, the battery management unit 14 operating as a controller may control the driving force of other electronic or electromechanical systems powered by a battery pack and motor. Examples include power tools, appliances, pumps, fans, or other devices or systems driven by a battery-powered motor.

In the aforementioned embodiments, the battery management unit 14 and/or motor driving unit 20 may be implemented in software, hardware, or both. When implemented in software, the apparatus in FIG. 1 may include a memory or other storage device for storing instructions for controlling the motor 30. These instructions may be executed by a processor (e.g., a microprocessor) or other type of computing device, and the instructions may perform the operations in the method of FIG. 3 and/or may perform the functions of the apparatus as previously described.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for controlling driving of an electric bike, comprising:
a motor to rotate a wheel of an electric bike;
a battery to provide power to the motor;
a battery manager to calculate a capacity degradation value of the battery; and
a motor driver to control torque of the motor according to the capacity degradation value of the battery.

2. The apparatus as claimed in claim 1, wherein the motor driver is to reduce the torque of the motor depending on the capacity degradation value of the battery.

3. The apparatus as claimed in claim 1, wherein the battery manager is to transmit the capacity degradation value of the battery to the motor driver.

4. The apparatus as claimed in claim 1, wherein the battery manager calculates the capacity degradation value according to a number of charging and/or discharging operations performed for the battery.

5. The apparatus as claimed in claim 1, wherein the battery manager is to calculate the capacity degradation value according to a difference between a charging capacity of the battery at a fully discharged state and an initial charging capacity of the battery.

6. An apparatus, comprising:
an interface; and
a controller to output a signal through the interface,
wherein the signal is to control at least one parameter of a motor based on a state of capacity degradation of a battery for driving the motor.

7. The apparatus as claimed in claim 6, wherein the at least one parameter is a torque of the motor.

8. The apparatus as claimed in claim 6, wherein the controller includes:
a driver coupled to the motor; and
a battery manager to determine a value indicative of the capacity degradation of the battery, the battery manager to output the value to the driver for generating the signal to control the at least one parameter.

9. The apparatus as claimed in claim 8, wherein the battery manager is to determine the value indicative of the capacity degradation of the battery based on a number of operations performed for the battery.

10. The apparatus as claimed in claim 9, wherein the number of operations performed for the battery includes at least one of a number of battery charging operations or a number of battery discharging operations.

11. The apparatus as claimed in 9, further comprising:
a storage device to store a look-up table,
wherein the look-up table includes a plurality of capacity degradation values corresponding to a respective plurality of numbers of operations performed for the battery, and wherein the battery manager is to determine the value indicative of the capacity degradation of the battery with reference to the look-up table.

12. The apparatus as claimed in claim 9, wherein the battery manager is to determine the capacity degradation of the battery based on information indicative of a capacity of the battery in a fully discharged state, an initial capacity of the battery, and a capacity of the battery determined based on the number of battery operations.

13. The apparatus as claimed in claim 6, wherein the interface is a signal line located between the controller and battery.

14. An apparatus, comprising:
an interface; and
a controller to output a signal through the interface,
wherein the signal includes a value indicative of a capacity degradation of a battery for driving a motor.

15. The apparatus as claimed in claim 14, wherein the controller is to determine the value indicative of the capacity degradation of the battery based on a number of operations performed for the battery.

16. The apparatus as claimed in claim 15, wherein the number of operations performed for the battery includes at least one of number of battery charging operations or a number of a battery discharging operations.

17. The apparatus as claimed in claim 16, further comprising:
a driver to drive the motor,
wherein the driver generates a signal to control at least one parameter of the motor based on the signal indicative of the capacity degradation of the battery.

18. The apparatus as claimed in claim 17, wherein the at least one parameter includes torque of the motor.

19. The apparatus as claimed in claim 14, wherein the interface is a signal in line located between the controller and motor.

20. The apparatus as claimed in claim 14, wherein the controller is to determine the value indicative of the capacity degradation of the battery based on a search of a look-up table of capacity degradation values stored in association with corresponding values indicative of a number of charging and/or discharging operations performed for the battery.
